(19) United States
(12) Patent Application Publication
(10) Pub. No.: US 2023/0052611 A1
(43) Pub. Date: Feb. 16, 2023

(54) INFORMATION PROCESSING DEVICE AND PROGRAM

(71) Applicant: TOSHIBA TEC KABUSHIKI KAISHA, Tokyo (JP)

(72) Inventors: Hidenori SOMEYA, Ichikawa Chiba (JP); Makoto NISHIDA, Yokohama Kanagawa (JP); Kazuki NAKAMURA, Ota Tokyo (JP)

(21) Appl. No.: 17/870,612

(22) Filed: Jul. 21, 2022

(30) Foreign Application Priority Data
Aug. 10, 2021 (JP) 2021-130827

(51) Int. Cl. G06Q 20/20

(52) U.S. Cl. CPC G06Q 20/209; G06Q 20/202

(57) ABSTRACT

According to an embodiment, an information processing device includes a control unit that is configured to store information relating to items of a plurality of stores at a shared facility and information relating to orders for the items of the plurality of stores. The control unit receives, from a terminal, an order for items of the plurality of stores. After a settlement process of the order is completed, the control unit transmits a settlement completion notice to the terminal and causes the terminal to display a settlement completion screen including a receipt request operator for transmitting a receipt request from the terminal. If the receipt request is transmitted from the terminal, and the order includes items from different stores in the plurality of stores, the control unit transmits separate electronic receipts for each of the different stores from which an item was ordered.

### CROSS-REFERENCE TO RELATED APPLICATION

This application is based upon and claims the benefit of priority from Japanese Patent Application No. 2021-130827, filed Aug. 10, 2021, the entire contents of which are incorporated herein by reference.

### FIELD

Embodiments described herein relate generally to an information processing device and a program.

### BACKGROUND

In a facility such as a shopping center, a restaurant quarter, often referred to as a food court, can be provided. In such a food court, a self-service type ordering service can be provided by which a customer orders desired items (foods and drinks) from the plurality of stores (restaurants) and thereafter brings the items to a table or the like by himself or herself to eat and drink. There is also a system in which a user can order and pay for items sold in the plurality of stores using a terminal device placed at a table or the like or a terminal device such as a smartphone carried by the user.

If a user orders and pays for items from a plurality of stores in the food court via a self-service terminal at the same time, then, unlike when the user orders and pays at counters of the individual stores, the user cannot acquire a receipt on which detail information of the purchased items are collectively printed for each of the stores from which the items were purchased.

On the other hand, in a system that provides detail information relating to one settlement in a retail store to be viewable in a form of a receipt, it is proposed to provide the detail information separately on a plurality of receipts (see, for example, JP-A-2014-194736). In such a system, detail information usually collected on one receipt can be separately displayed on a plurality of receipts. However, if the items from the plurality of stores are collectively purchased in the food court from a self-service terminal as explained above, this technique cannot issue receipts for each of the individual stores.

The food court is explained as an example above. However, besides the food court, the same problem could occur in various facilities where items or services can be purchased from a plurality of stores that provide for joint ordering and settlement of such multi-store transactions.

### BRIEF DESCRIPTION OF THE DRAWINGS

FIG. 1 is a diagram of an information processing system according to a first embodiment.

FIG. 2 is a diagram illustrating an example of a hardware configuration of a user terminal.

FIG. 3 is a diagram illustrating an example of a hardware configuration of a server device.

FIG. 4 is a diagram illustrating an example of a data configuration of a store information table.

FIG. 5 is a diagram illustrating an example of a data configuration of a menu management table.

FIG. 6 is a diagram illustrating an example of a data configuration of an order management table.

FIG. 7 is a diagram illustrating an example of a data configuration of a receipt management table.

FIG. 8 is a diagram illustrating an example of functional aspects of a user terminal and a server device.

FIG. 9 is a sequence chart illustrating a flow of operations of a user terminal and a server device from an order to settlement.

FIG. 10 is a diagram illustrating an example of a settlement completion screen.

FIG. 11 is a diagram illustrating an example of an order history screen.

FIG. 12 is a flowchart illustrating an example of a flow of processing performed by a server device after receiving an order.

FIG. 13 is a flowchart illustrating an example of a flow of processing when a server device receives an output of a receipt from an order history screen.

FIG. 14 is a diagram illustrating an example of a receipt screen.

FIG. 15 is a diagram illustrating another example of a receipt screen.

FIG. 16 is a diagram illustrating still another example of a receipt screen.

FIG. 17 is a diagram illustrating an example of a settlement completion screen according to a second embodiment.

### DETAILED DESCRIPTION

An object of certain embodiments is to make it possible to provide electronic or printed data including detail information regarding purchased items for each of the stores in a multi-store ordering and settlement transaction in a manner corresponding to conventional receipts from each of the individual stores.

According to one embodiment, an information processing device includes a control unit that is configured to store information relating to items of a plurality of stores at a shared facility and information relating to orders for the items of the plurality of stores. The control unit receives, from a terminal, an order for items of the plurality of stores. After a settlement process of the order is completed, the control unit transmits a settlement completion notice to the terminal and causes the terminal to display a settlement completion screen including a receipt request operator for transmitting a receipt request from the terminal. If the receipt request is transmitted from the terminal, and the order includes items from different stores in the plurality of stores, the control unit transmits separate electronic receipts for each of the different stores from which an item was ordered.

### First Embodiment

An information processing device and a program according to certain example embodiments are explained below with reference to the drawings. In an example explained below, a food court (as an example of a multi-store facility with a consolidated customer ordering service) provided in a shopping mall or the like is presented. However, embodiments are not limited to the specific examples.

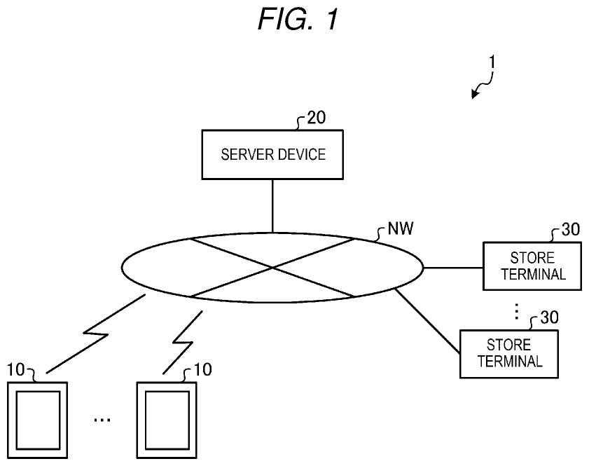

FIG. 1 is a diagram illustrating an example of the configuration of an information processing system according to one embodiment. As illustrated in FIG. 1, an information processing system 1 includes user terminals 10, a server device 20, and store terminals 30. The user terminals 10, the server device 20, and the store terminals 30 are communicably connected via a network NW which is a LAN (Local Area Network) provided in the food court.

The user terminals 10 are terminal devices used by customers (hereinafter referred to as users as well) who use the food court. The user terminals 10 are, for example, portable terminal devices such as smartphones or tablet terminals carried by the customers. The user terminals 10 may be dedicated terminal devices lent out to the users who use the food court. In the latter case, the user terminals 10 may be set in the tables provided in the food court.

The user terminals 10 are used to order food and drink items (hereinafter referred to as “commodities” as well) sold by stores in the food court. Specifically, the user terminals 10 provide operation screens for supporting user selection of commodities by the users. Upon receiving the selection of commodities from a user, the user terminals 10 transmit order information indicating the selected commodities to the server device 20.

The order information commodity IDs for specifying the ordered commodities and store IDs for identifying the stores that sell the commodities, as well as terminal information for identifying the user terminal 10 sending the order information. The terminal information is unique information such as an IP address, an electronic mail address, or a telephone number.

The user terminals 10 cooperate with the server device 20, an external settlement server, or the like to be capable of providing payment for the ordered commodities via electronic settlement. The method of the electronic settlement is not particularly limited. Existing techniques such as electronic money and credit card can be used. The order information becomes valid on condition that the settlement of the order target commodities is completed. For example, the server device 20 may be configured to receive the order information only after the settlement of the ordered commodities is completed.

The user terminals 10 are used to receive notices about the ordered commodities. Specifically, the user terminals 10 receive, from the store terminals 30, completion notifications for notifying that preparation of ordered commodities is completed. For example, upon receiving the completion notifications from a store terminal 30, the user terminals 10 output informing screens or sound to inform the users that the ordered commodities are ready for pickup or the like.

The server device 20 is an example of an information processing device. The server device 20 is communicably connected to external devices such as the user terminals 10 and the store terminals 30 via the network NW. The server device 20 cooperates with the user terminals 10 and the store terminals 30 to execute various kinds of information processing relating to orders of commodities.

For example, the server device 20 provides menu information concerning commodities sold in the stores of the food court to the user terminals 10. The menu information includes, for example, names, prices, explanations, and images of the commodities sold in the stores and relates to display of operation screens on which commodities can be selected for ordering. After receiving order information from a user terminal 10, the server device 20 stores and manages the received order information. The server device 20 cooperates with the store terminals 30 to track the states of the ordered commodities ordered.

Specifically, the server device 20 provides to the store terminals 30 of the stores that sell the ordered commodities screens (referred to as “order state screens”) that display contents of the user order(s) as a list. According to store operations made via the order state screens or the like, the server device 20 changes states of the ordered commodities or notifies the users who ordered the commodities. Additional aspects of the order state screens are explained below.

The server device 20 cooperates with, for example, an external settlement server to perform electronic settlement for the ordered commodities. The method of the electronic settlement is not particularly limited and various known techniques can be used. The server device 20 starts the management of the order information after settlement of the ordered commodities is completed. The server device 20 may calculate sales amounts due for each of the stores based on settlement content and notify the sales amounts to the store terminals 30 of the respective stores.

The store terminals 30 are terminal devices provided in the stores of the food court. The store terminals 30 are, for example, terminal devices such as kitchen display screen set in the corresponding kitchens of the stores or tablet terminals.

The store terminals 30 cooperate with the server device 20 to display order state screens showing order states of commodities sold in the stores. Store clerks working in the stores perform the cooking and the like of the ordered commodities based on the order state screens displayed on the store terminals 30. After preparation of the ordered commodities is completed, the store clerks perform an operation for calling/notifying the customers via the order state screens. The store terminals 30 receive input operations on the order state screens and notify content of the received operation to the server device 20.

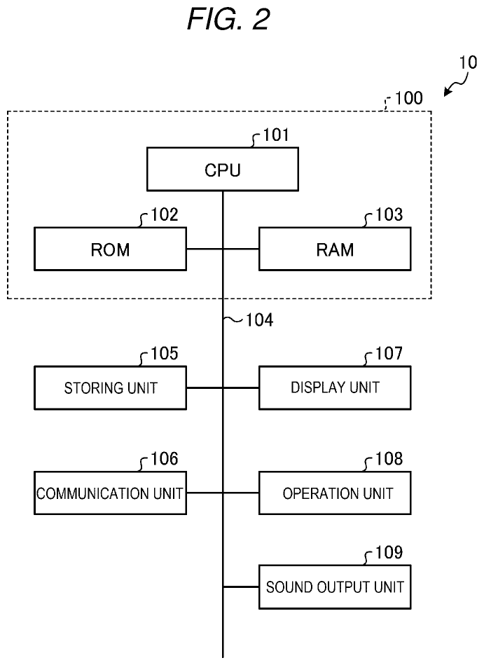

FIG. 2 is a diagram illustrating an example of a hardware configuration of the user terminal 10. As illustrated in FIG. 2, the user terminal 10 includes a CPU (Central Processing Unit) 101, a ROM (Read Only Memory) 102, and a RAM (Random Access Memory) 103.

The CPU 101 is an example of a processor that controls the overall operations of the user terminal 10. The ROM 102 stores various programs. The RAM 103 is a work space in which programs and various data are loaded. The CPU 101, the ROM 102, and the RAM 103 are connected via a bus 104 and form a control unit 100. In the control unit 100, the CPU 101 executes various kinds of processing by operating according to software programs and the like stored in the ROM 102 or a storing unit 105 and then loaded into the RAM 103 for execution.

The control unit 100 is connected to the storing unit 105 and a communication unit 106 via the bus 104. The storing unit 105 can be an HDD (Hard Disk Drive), a flash memory, or the like. The storing unit 105 maintains its stored content even if a power supply is turned off. The storing unit 105 stores various programs to be executed by the CPU 101 and various kinds of setting information relating to the operation of the user terminal 10. For example, the storing unit 105 stores an application program such as a browser relating to display of menu information provided from the server device 20.

The communication unit 106 is a wired or wireless communication interface connectable to the network NW. The communication unit 106 performs communication with an external device such as the server device 20 via the network NW.

A display unit 107, an input operation unit 108, a sound output unit 109, and the like are connected to the control unit 100 via the bus 104.

The display unit 107 is a display device such as an LCD (Liquid Crystal Display) and displays various kinds of information according to control of the control unit 100. The display unit 107 is realized by, for example, a touch panel display.

The input operation unit 108 includes various operation buttons and keys provides information corresponding to input operations of an operator to the control unit 100. The input operation unit 108 includes a touch panel provided on a display surface of the display unit 107.

The sound output unit 109 is a sound output device such as a speaker and outputs sound such as buzzer sound according to control of the control unit 100.

The hardware configuration of the user terminal 10 is not limited to the example illustrated in FIG. 2. For example, if the user terminal 10 is a smartphone, the user terminal 10 may include a communication module for 4G, 5G, or the like cellular communication and a sound input unit such as a microphone.

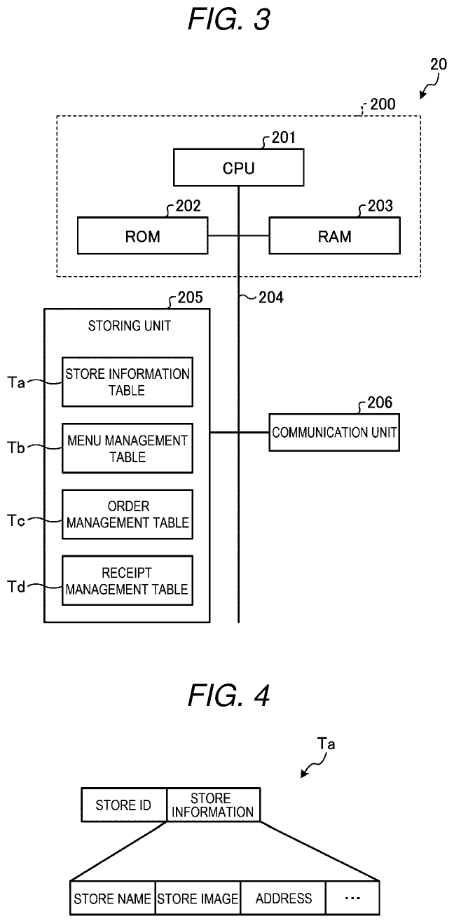

FIG. 3 is a diagram illustrating an example of a hardware configuration of the server device 20. As illustrated in FIG. 3, the server device 20 includes a CPU 201, a ROM 202, and a RAM 203.

The CPU 201 is an example of a processor and controls the overall operation of the server device 20. The ROM 202 stores various programs. The RAM 203 is a work space in which programs and various data are loaded. The CPU 201, the ROM 202, and the RAM 203 are connected via a bus 204 and form a control unit 200. In the control unit 200, the CPU 201 executes various kinds of processing by operating according to software programs or the like stored in the ROM 202 or a storing unit 205 and loaded into the RAM 203 for execution.

The control unit 200 is connected to the storing unit 205 and a communication unit 206 via the bus 204. The storing unit 205 can be an HDD, a flash memory, or the like and maintains stored content even if a power supply is turned off. The storing unit 205 stores various programs to be executed by the CPU 201 and various kinds of setting information relating to the operation of the server device 20. In particular, in this example, the storing unit 205 stores a store information table Ta, a menu management table Tb, an order management table Tc, a receipt management table Td. The menu management table Tb is an example of a commodity-information storing unit. The order management table Tc is an example of an order-information storing unit.

The store information table Ta stores information concerning stores at the food court. FIG. 4 is a diagram illustrating an example of a data configuration of the store information table Ta. As illustrated in FIG. 4, the store information table Ta stores store information concerning the stores by store IDs.

The store information includes items such as a store name, a store image, and an address. The store name can be information indicating store names, trade names, abbreviations, or the like of the stores. The store image can be image data representing the stores such as logos or stylized store names for the stores. The address is address information relating to communication with the store terminals 30 such as IP addresses or host names of the store terminals 30.

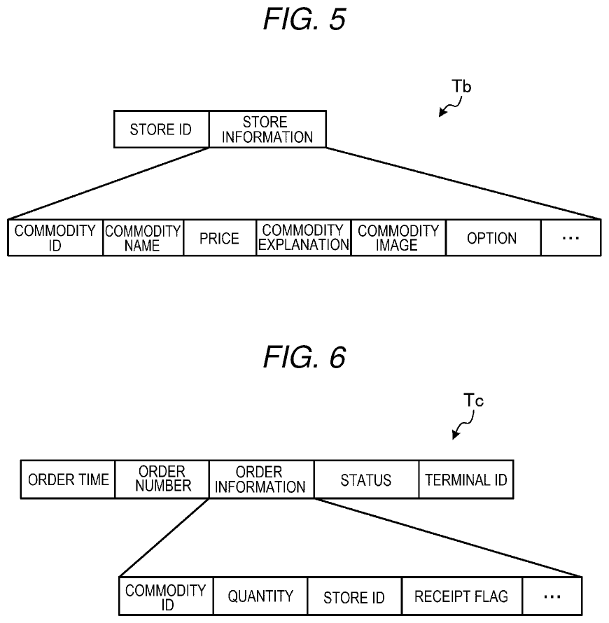

The menu management table Tb stores information concerning commodities handled by the plurality of stores included in the food court. FIG. 5 is a diagram illustrating an example of a data configuration of the menu management table Tb. As illustrated in FIG. 5, the menu management table Tb stores menu information of commodities sold in the stores corresponding by the store IDs.

The menu information includes entries such as a commodity ID, a commodity name, a price, a commodity explanation, a commodity image, and options. The commodity ID is identification information for identifying each item. The commodity name is information indicating names or abbreviations of the item. The price is information indicating the price per item. Various other kinds of information concerning the commodities can be stored in the commodity explanation section. For example, information concerning ingredients included in the item and cooking time required for item can be stored in the commodity explanation section.

The commodity image is image data depicting the item (e.g., a representative picture of the item). The option section includes information indicating it is possible for the customer to designate variations of the item, for example a serving size such as “large serving”, a request for an additional topping, sauce selection, or the like. For example, the option section in this example includes information such as selectable serving size and/or selectable topping types. The option may also include information concerning additional charges corresponding to customer choices of serving size and/or topping.

The order management table Tc stores order information transmitted from the user terminals 10. The order information is information relating to orders of items listed in the menu management table Tb. FIG. 6 is a diagram illustrating an example of a data configuration of the order management table Tc. As illustrated in FIG. 6, the order management table Tc stores information such as an order time, an order number, a terminal ID, order information, and a status in correlation with one another.

The order time is date and time information indicating the date and time when the order information was received. The order number is number information indicating order of the reception of the order information. For example, ascending-order numbers are given in the order of the reception of the order information. The terminal ID is terminal information of the user terminal 10 sending the order.

The order information includes a commodity ID and a quantity of ordered item, a store ID of a store that sells the ordered item, and a receipt flag. If an option such as large serving is selected when the item is ordered, content such as serving size and a selected topping type is stored as a part of the order information in correlation with the ordered item.

The receipt flag indicates whether a receipt for the order has already been issued. The receipt flag in this embodiment takes value “0” to indicate that the receipt is not issued yet and value “1” to indicate the receipt has been issued at least once.

The status information indicates a present state of the order information. In the status field or section, the state is listed as one of series of states in a plurality of stages from order reception to hand-over (complete). The plurality of stages from the reception of the order to the hand-over are considered states to be tracked. For example, states such as “new” indicating a state immediately after the order reception, “cooking” indicating that the commodity is being cooked, “cooking completed” indicating the cooking is completed but the customer is not yet called, “calling” indicating that a customer has been called, and “hand-over completed” indicating that the commodity was handed over to the customer are tracked.

The server device 20 in this embodiment dispenses a receipt according to a request from the user terminal 10. The receipt is an example of purchase detail information.

The receipt is created based on information extracted from the order management table Tc. More specifically, if an output request is received from the user terminal 10, the receipt is output in a predetermined format based on information stored by the order management table Tc for an order relating to the output request. If the order relating to the output request includes items from a plurality of stores, the receipt in this embodiment is separately output for each of these different stores.

The receipt in this embodiment is electronic data and is, for example, a data file of a PDF format. The user terminal 10 that received the issuance of the receipt may cause the display unit 107 to display the received receipt, which is the electronic data, may cause the storing unit 105 to store the receipt, or may cause an external device such as a printer connected through the communication unit 106 to print the receipt.

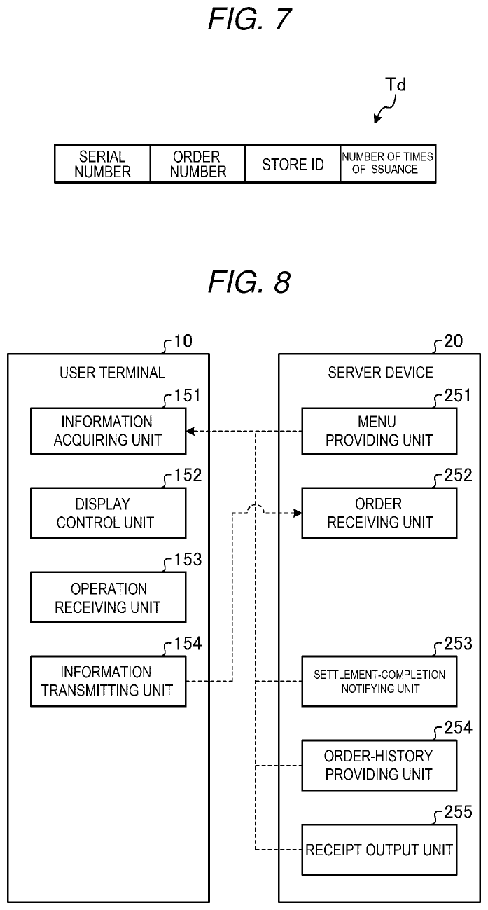

FIG. 7 is a diagram illustrating an example of a data configuration of the receipt management table Td. The receipt management table Td stores information concerning an issued receipt. As illustrated in FIG. 7, the receipt management table Td stores an order number, a store ID, the number of times of issuance, and the like in correlation with a serial number.

The serial number can be numeric information indicating the order of issuance of a receipt by the server device 20. For example, ascending-order numbers are given in the order of issuance of receipts. In this embodiment, a unique serial number is given every time a new record is created in the receipt management table Td. The order number and the store ID are acquired from the order management table Tc based on an output request received from the user terminal 10 when the receipt is issued.

The value for the number of times of issuance indicates the number of times a receipt of the same order has been issued. In this embodiment, according to first issuance of a receipt of a certain order, a receipt flag relating to the order (included in the order information of the order management table Tc) is updated from “0” to “1”. A record is created in the receipt management table Td and the number of times of issuance of the record is set to “1”. According to reissuance of a receipt for an order, a receipt flag of which is already “1”, a new record is created in the receipt management table Td. The number of times of issuance of the record is a value obtained by adding one to the number of times of issuance at the last issuance time.

Referring back to FIG. 3, the communication unit 206 is a wired or wireless communication interface connectable to the network NW. The communication unit 206 performs communication with external devices such as the user terminals 10 and the store terminals 30 via the network NW.

The hardware configuration of the server device 20 is not limited to the example illustrated in FIG. 3. For example, in FIG. 3, the server device 20 is configured to store, in the storing unit 205, the store information table Ta, the menu management table Tb, the order management table Tc, and the receipt management table Td. However, an external device (for example, a database server) accessible by the server device 20 may be used to store any one or all of the store information table Ta, the menu management table Tb, the order management table Tc, and the receipt management table Td.

FIG. 8 is a diagram illustrating an example of the functional aspects of the user terminal 10 and the server device 20. In FIG. 8, functions interacting between the devices are connected by broken lines.

The user terminal 10 includes an information acquiring unit 151, a display control unit 152, an operation receiving unit 153, and an information transmitting unit 154 as functional components.

A part or all of the functions provided by the user terminal 10 may be realized by the control unit 100, that is, as software components realized by cooperation of a processor (for example, the CPU 101) of the user terminal 10 and a program stored in a memory (for example, the ROM 102 or the storing unit 105) of the user terminal 10. In other examples, part or all of the functions provided by the user terminal 10 may be provided by hardware components such as dedicated circuits or the like mounted in the user terminal 10.

The server device 20 includes a menu providing unit 251, an order receiving unit 252, a settlement-completion notifying unit 253, an order-history providing unit 254, and a receipt output unit 255 as functional components.

A part or all of the functions provided by the server device 20 may be realized by the control unit 200, that is, as software components realized by cooperation of a processor (for example, the CPU 201) of the server device 20 and a program stored in a memory (for example, the ROM 202 or the storing unit 205) of the server device 20. In other examples, part or all of the functions provided by the server device 20 may be provided by hardware components such as dedicated circuits or the like mounted in the server device 20.

The information acquiring unit 151 receives information from an external device such as the server device 20. The display control unit 152 controls display of the display unit 107 and causes the display unit 107 to display an image based on information received from the external device such as the server device 20. The operation receiving unit 153 receives operation of a user via the input operation unit 108. The information transmitting unit 154 transmits content of the operation received by the operation receiving unit 153 to the external device such as the server device 20.

In the user terminal 10, GUIs (Graphic User Interfaces) for various functional units (e.g., the information acquiring unit 151, the display control unit 152, the operation receiving unit 153, and the information transmitting unit 154) may be realized using a Web browser or dedicated application software.

The menu providing unit 251 provides information concerning a menu stored by the menu management table Tb to the user terminal 10. The menu information may be provided as a list of menu items that are selectable by the user. The menu providing unit 251 transmits, for example, information for causing the display unit 107 to display operators (buttons, hyperlinks, or the like) indicating the available choices.

The order receiving unit 252 receives, from the user terminal 10, an order of a selected menu item and causes the order management table Tc to store the order. The order receiving unit 252 is capable of receiving orders for a plurality of commodities at the same time rather than receiving the orders one by one. Additionally, the order receiving unit 252 is capable of receiving orders for a plurality of stores at the same time. That is, a user may order menu items from multiple stores in the same ordering transaction/event.

In this embodiment, settlement processing for received orders is collectively performed. In this embodiment, a commodity purchase is completed when settlement of the price of the item(s) in the order is completed (that is, payment is made for the ordered item(s)).

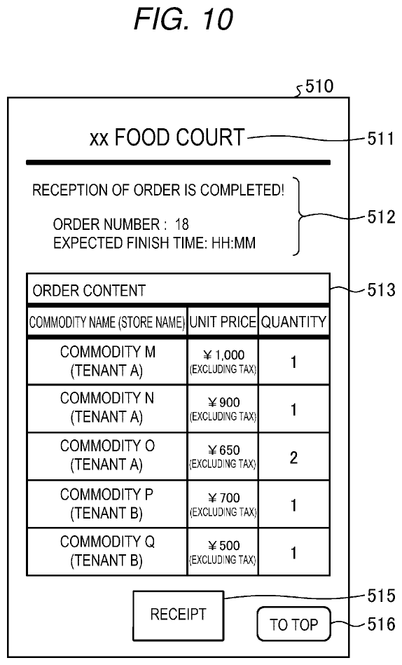

After settlement completion for an order received by the order receiving unit 252, the settlement-completion notifying unit 253 notifies the user terminal 10 of the settlement completion and causes the user terminal 10 to display a settlement completion screen (for example, a settlement completion screen 510 illustrated in FIG. 10). The settlement completion screen permits the user to enter an output request for a receipt. The settlement-completion notifying unit 253 provides, in the settlement completion screen, a receipt button for requesting, from all the stores involved in the transaction, a receipt.

The receipt output unit 255 is an example of a detail-information output unit. If receiving aa request for a receipt via the settlement completion screen, the receipt output unit 255 outputs, based on information stored by the order management table Tc a receipt in a predetermined format for the order.

The receipt in this context can be electronic data such as a PDF file. The receipt request includes an identifier for identifying the relevant order. The identifier is, for example, an order number.

If an order includes commodities from a plurality of stores, the receipt output unit 255 in this example outputs receipts separately for each of the stores. For example, the receipt output unit 255 outputs a separate receipt for each of the stores. That is, if the order involves commodities from three different stores, then three separate receipts are generated (one for each store).

Upon output of the receipt, the receipt output unit 255 causes the order management table Tc to store a receipt flag indicating the receipt has already been output. The receipt output unit 255 checks the receipt flag prior to an output of a receipt after receiving a receipt request. If a receipt was already output, the receipt output unit 255 outputs another receipt including text or a symbol indicating that the new receipt is a reissued receipt.

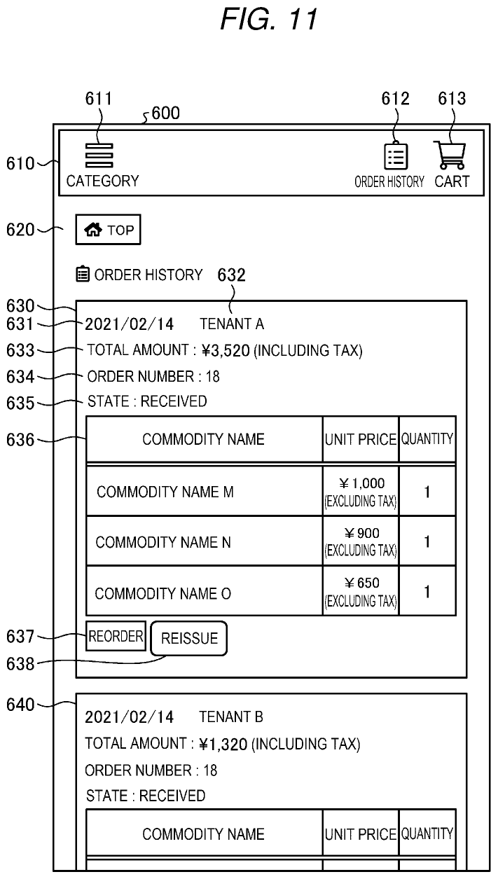

Upon a request from the user terminal 10, the order-history providing unit 254 causes the user terminal 10 to display an order history screen (for example, an order history screen 600 illustrated in FIG. 11). The order history screen provides information stored by the order management table Tc and can receive a request for a receipt. Upon receiving a request for a receipt via the order history screen, the receipt output unit 255 outputs a receipt of an order indicated by the order history screen.

The order-history providing unit 254 includes, in the order history screen, a designated store receipt button (for example, a button 638 illustrated in FIG. 11) for receiving a request for a receipt from a designated (user selected) store. If the designated store receipt button is pressed/selected, the receipt output unit 255 outputs a receipt from the store designated.

The order-history providing unit 254 checks the receipt flag and, displays text or a symbol indicating that the receipt has been previously issued if the receipt of the order was previously output.

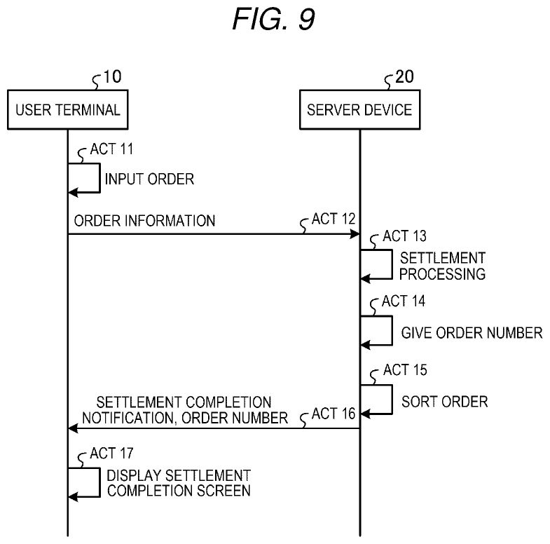

FIG. 9 is a sequence chart illustrating a flow of operations of the user terminal 10 and the server device 20 from an order to settlement.

In the present example, the user can operate the user terminal 10 and order a commodity irrespective of whether the user is inside the food court or outside the food court. The input relating to an order is performed on the user terminal 10 by the user (Act 11).

If the order is made, the user terminal 10 outputs order information to the server device 20 (Act 12). The order information output from the user terminal 10 includes a terminal ID, a commodity ID for identifying an ordered commodity, and a store ID for identifying a store that provides the ordered commodity.

The server device 20 executes settlement processing based on the order information from the user terminal 10 (Act 13). The server device 20 executes the settlement processing according to an existing technique. For example, the server device 20 requests, through the user terminal 10, the user to input credit card information, then communicates with a credit card settlement server managed by a settlement agent (credit card service), and performs settlement relating to the ordered commodity using the credit card information transmitted from the user terminal 10.

The server device 20 gives an order number to the received order information (Act 14). Subsequently, the server device 20 executes order sorting processing based on the received order information (Act 15). The order sorting processing is processing for sorting the ordered items indicated by the order information to each of the relevant stores. The server device 20 outputs the sorted information relating to the ordered items to the store terminals 30 of the relevant stores.

Upon finishing the settlement processing or the like, the server device 20 outputs an order completion notification indicating that the reception of the order is completed and supplies the given order number to the user terminal 10 (Act 16).

The user terminal 10 displays a settlement completion screen 510 based on the information acquired from the server device 20 (Act 17). FIG. 10 is a diagram illustrating an example of the settlement completion screen 510. On the settlement completion screen 510, a facility name region 511, a message region 512, an order information region 513, a receipt button 515, a button 516 for instructing a shift to a top screen, and the like are formed.

In the message region 512, a message indicating that the reception of the order is completed, the order number given by the server device 20, an expected provision time as calculated by the server device 20, and the like are displayed. For example, in the order information region 513, a name of an ordered item (a commodity name), a store name that provides the commodity, a unit price of the item, and an ordered quantity of the item are displayed in association with one another.

The receipt button 515 is a button for receiving (then displaying) a receipt. If the receipt button 515 is operated, the control unit 100 of the user terminal 10 generates a request (receipt request) including at least the order number and transmits the request to the server device 20. The server device 20 then transmits the electronic data serving as a receipt to the user terminal 10.

The user can display, by operation from the user terminal 10, an order history screen 600 for displaying a history of orders received by the server device 20. FIG. 11 is a diagram illustrating an example of the order history screen 600. The order history screen 600 is a screen for displaying information recorded in a record of the order management table Tc and includes a system menu 610, a title region 620, and order information regions 630 and 640.

The system menu 610 includes a category button 611, an order history button 612, and a cart button 613.

The title region 620 includes text such as “order history” indicating that this screen is the order history screen 600 and a button for instructing a shift to the top screen.

The order information regions 630 and 640 display information acquired from a record of the order management table Tc. The order information regions 630 and 640 include an order date 631, a store name 632, a total amount 633 of prices of ordered commodities, an order number 634, a status 635, details 636, a reorder button 637, and a receipt button 638. The receipt button 638 included in the order information region 630 is a button for outputting a receipt of commodities M, N, and 0 provided by a tenant A. The receipt button 638 included in the order information region 640 is a button for outputting a receipt of commodities P and Q provided by a tenant B.

In the details 636, a name of an ordered item (a commodity name), a unit price of the item, and an ordered quantity of the item are displayed in association with one another. A store ID may be included in the order history screen 600 to be added to the request transmitted when the receipt button 638 is pressed (it does not matter whether the store ID is included in a visible state).

On the receipt button 638 of the order history screen 600, if a record of issuance of a receipt of the order in the past is present, for example, “reissue” or the like is displayed in order to clearly indicate that the record of the previous issuance of the receipt is present. If a record of issuance of a receipt of the order in the past is absent, that is, if the receipt button 515 was not pressed on the settlement completion screen 510, for example, then just “receipt” is displayed on the receipt button 638 of the order history screen 600.

If the receipt button 638 on the order history screen 600 is pressed, the control unit 100 of the user terminal 10 generates a request including at least the order number 634 and the store information (the store name 632 or the store ID) in the same order information region 630 and transmits the output request to the server device 20.

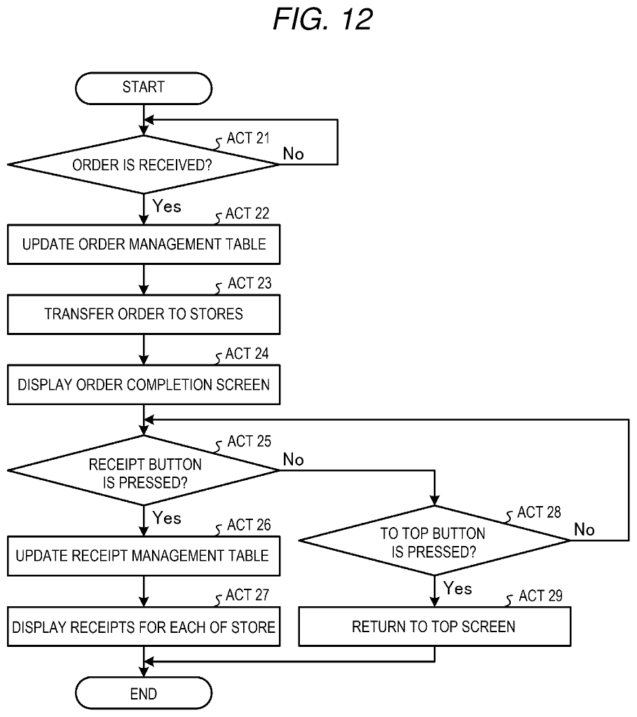

FIG. 12 is a flowchart illustrating an example of a flow of processing performed by the server device 20 after reception of an order. The server device 20 waits for reception of an order from the user terminal 10 (No in Act 21) and, upon receiving an order (Yes in Act 21), updates the order management table Tc based on the order content, that is, generates a new record (Act 22). An order number is given (assigned) here to the order.

Subsequently, the server device 20 transfers the order content to the relevant store(s) (Act 23) and causes the user terminal 10 to display a settlement completion screen 510 (Act 24).

If the receipt button 515 is pressed on the settlement completion screen 510 (Yes in Act 25), a request including at least the order number is transmitted from the user terminal 10 to the server device 20. Then, the server device 20 extracts, from the order management table Tc, the record corresponding to the order number included in the received receipt request, collects the extracted information for each of store IDs, and generates a new record (or records) in the receipt management table Td. That is, the server device 20 updates the receipt management table Td (Act 26). The server 20 transmits the receipt record(s) generated in Act 26 to the user terminal 10 and causes the user terminal 10 to display a receipt for each of the stores involved in the order (Act 27). In this example, the receipts for each of the stores are PDF data files depicting the receipt information in a predetermined format.

If the receipt button 515 is not pressed in Act 25 (No in Act 25) and the button 516 for instructing a shift back to the top screen is pressed (Yes in Act 28), the server device 20 transmits screen data for causing the user terminal 10 to display the top screen (Act 29). If the button 516 is not pressed in Act 28 (No in Act 28), the server device 20 returns to Act 25.

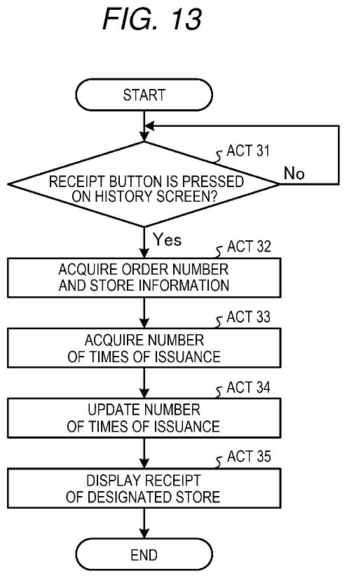

FIG. 13 is a flowchart illustrating an example of a flow of processing at the time when the server device 20 receives a request for a receipt via the order history screen 600.

The server device 20 waits for operation from the user terminal 10 during the display of the order history screen 600 (No in Act 31). If the receipt button 638 is pressed on the order history screen 600 (Yes in Act 31), a request including at least the order number 634 and the store information (the store name 632 or the store ID) is transmitted from the user terminal 10 to the server device 20. The server device 20 acquires, based on the request, the order number and store information for which a receipt should be output (Act 32).

The server device 20 extracts, from the order management table Tc, order information corresponding to the order number and the store information acquired in Act 32 and also acquires information indicating the number of times a receipt has been previously issued regarding the same receipt information (Act 33). That is, the server device 20 checks the receipt flag of the corresponding extracted record and, if the receipt flag is “1”, extracts from the receipt management table Td a record corresponding to the order number and the store ID acquired in Act 32 and checks the listed number of times of issuance. If the receipt flag is “0”, the number of times of prior issuance is “0”.

The server device 20 generates a new record in the receipt management table Td based on the record extracted from the order management table Tc. The number of times of issuance is updated. The server device 20 transmits receipt information to the user terminal 10 and causes the user terminal 10 to display a receipt of a designated store (Act 35).

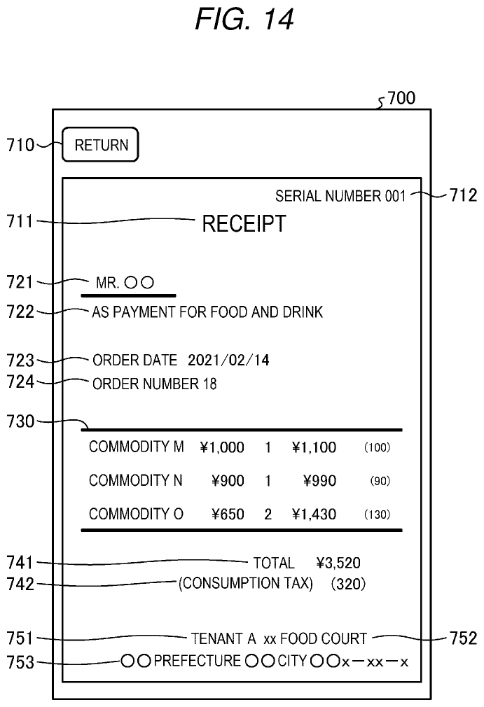

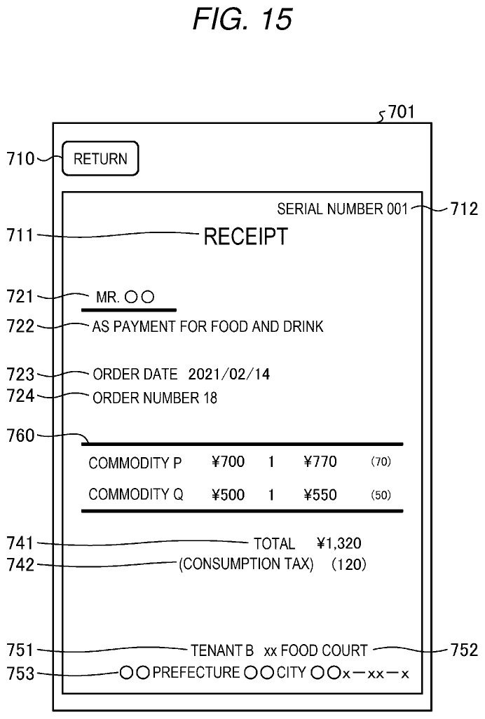

FIGS. 14 and 15 are diagrams illustrating examples of receipt screens 700 and 701. The receipt screens 700 and 701 are displayed on the display unit 107. The receipt screens 700 and 701 are screens on which receipts issued for the first time are displayed.

The receipt screens 700 and 701 include a return button 710, a title 711, a serial number 712, an addressee's name 721, a note 722, an order date 723, an order number 724, details 730 and 760, a total amount 741, a consumption tax amount 742, store names 751 and 761, a facility name 752, and an address 753.

The return button 710 is a button for receiving an instruction for returning to the previous screen. If the return button 710 is pressed, a request for shifting to another screen (for example, the settlement completion screen 510) displayed before this presently displayed screen is transmitted from the user terminal 10 to the server device 20.

In the title 711, text “receipt” indicating that this screen is a receipt screen (e.g., either one of screens 700 and 701) is displayed. The serial number 712 is acquired from the record of the receipt management table Td.

In the addressee's name 721, a GUI box or other operator for requesting the input of the user name may be displayed as appropriate, for example, if the receipt button 515 (or 638) is pressed. The note 722 may be a fixed phrase or various choices may be available as the note 722 by using the GUI to select a choice (e.g., a drop-down box) or otherwise provide a user input of text or the like.

The order date 723 and the order number 724 are acquired from the record of the order management table Tc. In the details 730, a name of an ordered item (a commodity name), a unit price of the item, and an ordered quantity of the item acquired from the record of the order management table Tc are displayed in association with one another. The total amount 741 and the consumption tax amount 742 are calculated based on the information stored in the order management table Tc and the menu management table Tb. The store name 751 is acquired from the store information table Ta. The facility name 752 and the address 753 are information for the food court, for example. Therefore, the facility name 752 and the address 753 may be included as a format setting in some examples.

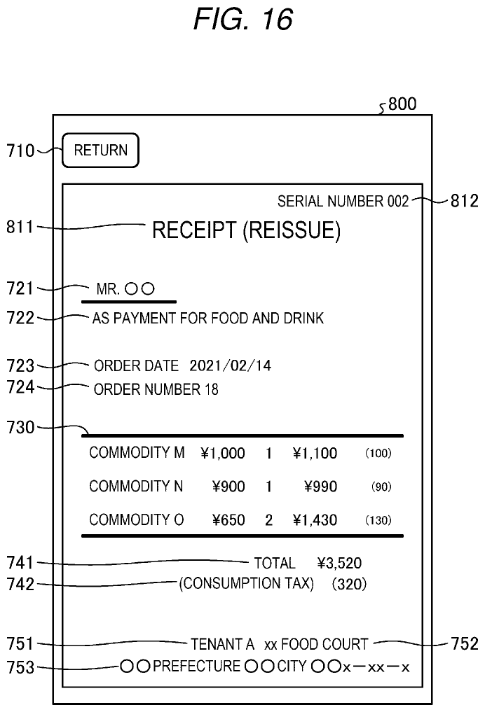

FIG. 16 is a diagram illustrating an example of a receipt screen 800. The receipt screen 800 is displayed on the display unit 107. The receipt screen 800 is a screen on which a reissued receipt is displayed.

The receipt screen 800 is a screen on which substantially the same details as displayed on the receipt screen 700 are displayed. The title 811 and the serial number 812 are different from the title 711 and the serial number 712 of the receipt screen 700. Text “receipts (reissued)” is displayed in the title 811. Consequently, this screen indicates that a reissued receipt is being displayed. The serial number 812 is acquired from the record of the receipt management table Td.

In such a configuration, if the receipt button 515 is pressed on the settlement completion screen 510 (illustrated in FIG. 10), the server device 20 acquires information to be displayed on the receipt screens 700 and 701 illustrated in FIGS. 14 and 15 from the order management table Tc, updates the receipt flag from “0” to “1”, and records the issuance of the receipt in the receipt management table Td.

If the settlement indicated by the settlement completion screen 510 is settlement relating to a collective order of commodities of a plurality of stores, the server device 20 outputs details of the order relating to the settlement as receipts separated for each of the stores.

If the receipt button 638 is pressed on the order history screen 600 illustrated in FIG. 11, the server device 20 acquires, from the order management table Tc, information to be displayed on the receipt screens 700 and 701 illustrated in FIGS. 14 and 15 or the receipt screen 800 illustrated in FIG. 16 and, if the receipt flag is “0”, updates the receipt flag to “1”, and records the issuance of the receipt in the receipt management table Td.

As explained above, according to this first embodiment, if items from a plurality of stores are purchased in the same transaction, it is possible to provide electronic data or printed output on which detail information of the purchased items for each of the stores is collected for each of the stores.

If a receipt is issued a plurality of times, characters such as “reissued” can be displayed on second and subsequent receipts. Therefore, it is possible to contribute to suppression of potentially fraudulent use of the generated receipts.

In this example, a sales transaction receipt is explained as an example of the transaction detail information to be provided upon user request. However, in other examples, the transaction detail information may be something other than information regarding a sales transaction. The transaction detail information may be electronic data or a printed related to non-retail product or service ordering. The output of the transaction detail information is explained as a screen displayed on a portable terminal or the like in this example. However, in other examples, the output of the transaction detail information may be provided as a downloadable or downloaded file or may be provided as issuance of a print instruction (e.g., a print request/command sent to a printer).

The flag information (the receipt flag) of an example is described as stored in the order management table Tc. However, in other examples, the storing unit 205 may be used to store the flag information separately from the order management table Tc.

In some examples, the server device 20 may transmit, upon settlement completion, an electronic mail to the user terminal 10 indicating the settlement completion. In doing so, a hyperlink to the receipt screens 700 and 701 or the order history screen 600 may be provided in the electronic mail.

Various modifications are to the example(s) described above will be noted below. In the following explanation, the differences in these modifications from the previously explained examples are primarily explained, and detailed explanation is omitted for those points common to the those already explained above. These various modifications may be individually implemented or may be combined with one another as appropriate.

The food court is explained as a non-limiting example. However, in general, any facility which a plurality of stores, vendors, and/or outlets might share and implement, or otherwise provide for, a common (shared) ordering system or service may be adopted instead of a food court.

### Second Embodiment

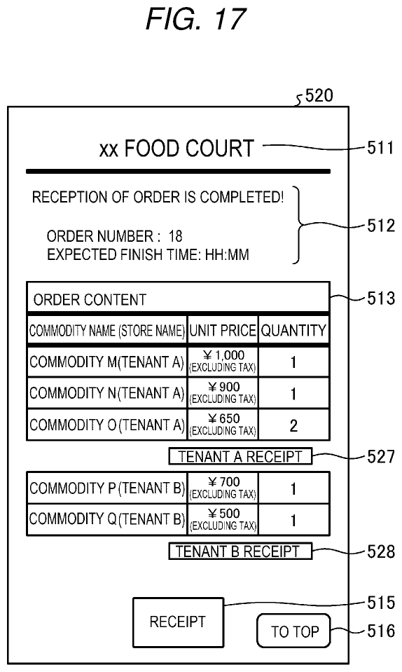

FIG. 17 is a diagram illustrating an example of a settlement completion screen 520 according to a second embodiment. In this second embodiment, the settlement completion screen 520 that the settlement-completion notifying unit 253 causes the user terminal 10 to display further includes designated store receipt buttons 527 and 528 in addition to the regions and the buttons of the settlement completion screen 510 in the first embodiment.

The designated store receipt buttons 527 and 528 are for receiving a request for a receipt from a designated store. The designated store receipt button 527 in this example is a button for outputting a receipt for the commodities M, N, and 0 provided by the tenant A. The designated store receipt button 528 is a button for outputting a receipt for the commodities P and Q provided by the tenant B.

If the designated store receipt buttons 527 and 528 are pressed, the receipt output unit 255 outputs a receipt of the selected store(s).

More specifically, if the designated store receipt buttons 527 and 528 are pressed on the settlement completion screen 520, the user terminal 10 transmits a request including an order number and store information (a store name and a store ID) to the server device 20. The processing of the server device 20 is the same as Act 32 and subsequent acts of the processing are as explained with reference to FIG. 13 for the first embodiment.

According the second embodiment, a receipt can be issued only for a desired store on the settlement completion screen 520. Consequently, since an unnecessary receipt is not issued at that point in time, if a receipt is necessary later, a receipt issued for the first time can be obtained.

The programs executed in the devices in the above embodiments can be provided by being incorporated in a ROM or the like in advance. The programs executed in the devices explained above may be provided by being recorded in a non-transitory computer-readable recording medium such as a CD-ROM, a flexible disk (FD), a CD-R, or a DVD (Digital Versatile Disk) as a file of an installable form or an executable form.

Further, the programs executed in the devices in the embodiments explained above may be provided by being stored on a computer connected to a network such as the Internet and downloaded through the network. The programs executed in the devices in the embodiments explained above may be provided or distributed through the network such as the Internet.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device, comprising:
a control unit configured to:
store information relating to items of a plurality of stores at a shared facility;
store information relating to orders for the items of the plurality of stores;
receive, from a terminal, an order for items of the plurality of stores;
after a settlement process of the order is completed, transmit a settlement completion notice to the terminal and cause the terminal to display a settlement completion screen including a receipt request operator for transmitting a receipt request from the terminal; and
if the receipt request is transmitted from the terminal and the order includes items from different stores in the plurality of stores, transmit separate electronic receipts for each of the different stores from which an item was ordered.

2. The information processing device according to claim 1, wherein the settlement completion screen includes a store designation operator for designating a particular store in the plurality of stores from which to receive an electronic receipt.

3. The information processing device according to claim 1, wherein the control unit is further configured to store flag information indicating whether an electronic receipt for the order was already output.

4. The information processing device according to claim 3, wherein a second or subsequent receipt request provides an electronic receipt indicating a reissuance.

5. The information processing device according to claim 3, wherein the control unit is further configured to cause the terminal to display an order history screen from which electronic receipts from previous orders can be requested.

6. The information processing device according to claim 5, wherein
the order history screen includes a store designation operator for designating a particular store in the plurality of stores from which to receive an electronic receipt.

7. The information processing device according to claim 1, wherein the control unit includes a processor.

8. The information processing device according to claim 1, further comprising:
a communication interface configured to connect to the terminal.

9. An information processing method for an electronic receipt service, the method comprising:
storing information relating to items of a plurality of stores at a shared facility;
storing information relating to orders for the items of the plurality of stores;
receiving, from a terminal, an order for items of the plurality of stores;
transmitting a settlement completion notice to the terminal and causing the terminal to display a settlement completion screen including a receipt request operator for transmitting a receipt request from the terminal after a settlement process of the order is completed; and
transmitting separate electronic receipts for each of the different stores from which an item was ordered if the receipt request is transmitted from the terminal and the order includes items from different stores in the plurality of stores.

10. The information processing method according to claim 9, wherein the settlement completion screen includes a store designation operator for designating a particular store in the plurality of stores from which to receive an electronic receipt.

11. The information processing method according to claim 9, further comprising:
storing flag information indicating whether an electronic receipt for the order was already output.

12. The information processing method according to claim 11, wherein a second or subsequent receipt request provides an electronic receipt indicating a reissuance.

13. The information processing method according to claim 11, further comprising:
causing the terminal to display an order history screen from which electronic receipts from previous orders can be requested.

14. The information processing method according to claim 13, wherein the order history screen includes a store designation operator for designating a particular store in the plurality of stores from which to receive an electronic receipt.

15. The information processing method according to claim 9, wherein the shared facility is a food court.

16. The information processing method according to claim 9, wherein the plurality of stores are restaurants.

17. A non-transitory, computer-readable medium storing program instructions which when executed by a control unit of an information processing device causes the information processing device to perform a method comprising:
storing information relating to items of a plurality of stores at a shared facility;
storing information relating to orders for the items of the plurality of stores;
receiving, from a terminal, an order for items of the plurality of stores;
transmitting a settlement completion notice to the terminal and causing the terminal to display a settlement completion screen including a receipt request operator for transmitting a receipt request from the terminal after a settlement process of the order is completed; and
transmitting separate electronic receipts for each of the different stores from which an item was ordered if the receipt request is transmitted from the terminal and the order includes items from different stores in the plurality of stores.

18. The non-transitory, computer-readable medium according to claim 17, wherein the settlement completion screen includes a store designation operator for designating a particular store in the plurality of stores from which to receive an electronic receipt.

19. The non-transitory, computer-readable medium according to claim 17, wherein the method further comprises:
storing flag information indicating whether an electronic receipt for the order was already output, wherein
a second or subsequent receipt request provides an electronic receipt indicating a reissuance.

20. The non-transitory, computer-readable medium according to claim 17, wherein the method further comprises:
causing the terminal to display an order history screen from which electronic receipts from previous orders can be requested.
